(19) United States
(12) Patent Application Publication
(10) Pub. No.: US 2015/0216129 A1
(43) Pub. Date: Aug. 6, 2015

(54) PLANTING SPONGE AND METHOD FOR MANUFACTURING THE SAME

(71) Applicant: SHINKONG IECOFUN CORPORATION, TAIPEI (TW)

(72) Inventor: JUNG-KUN CHEN, TAIPEI (TW)

(21) Appl. No.: 14/605,582

(22) Filed: Jan. 26, 2015

(30) Foreign Application Priority Data
Jan. 27, 2014 (TW) 103102870

(51) Int. Cl. A01G 5/06; B29C 44/56; B29C 44/02

(52) U.S. Cl. CPC A01G 5/06; B29C 44/022; B29C 44/5654; B29L 2031/608

(57) ABSTRACT

The present invention relates to a planting sponge, which comprises a phenolic resin body and at least one far-infrared element intermixed within the phenolic resin body. The present invention also relates to a method for manufacturing the aforesaid planting sponge, which comprises the steps of injecting materials, mixing and foaming-molding.

### FIELD OF THE INVENTION

The present invention relates to a planting sponge, and in particular, relates to a planting sponge for crop planting, cutting propagation and seed seedling. The present invention also relates to a method for manufacturing the planting sponge.

### BACKGROUND OF THE INVENTION

With regard to the conventional crop planting, the seed of the crop is directly planted into the soil and then the needed nutrients such as water, fertilizer and etc. during the growth of the crop are applied therein.

With regard to the soil mentioned above, in addition to the soil in the ground of the farm land, a container with the soil disposed therein can also be used to plant the crop.

As mentioned above, in order to provide the crop with sufficient nutrients during the growth of the crop, people will apply the nutrients such as water, fertilizer and etc. are applied to the soil, which is labor-consuming, time-consuming and also causes higher cost for the attendance of the crop planting. Further, when using the soil to plant the crop, the soil could easily breed the bacteria which are harmful to the crop, and the soil also could let the crop to be subjected to the damage due to the insects. Hence, improvements are still needed for conventional crop planting with the soil.

Recently, a sponge is used to plant crop thereon. In this manner, although some problems with regard to the crop planting with the soil as mentioned above could be avoid, however, the sponge cannot retain and absorb sufficient water. Hence, for sponge, the attendance for the crop is also not easy; for example, it is necessary to provide the sponge with the water frequently. Further, using the sponge to plant the crop cannot be applied to all kinds of crops, and therefore it is also inconvenient when in use.

### SUMMARY OF THE INVENTION

The planting sponge of the present invention comprises a phenolic resin sponge and at least one far-infrared element intermixed within the phenolic resin sponge.

In the aforesaid planting sponge, the ratio of the at least one far-infrared element to the phenolic resin sponge is between 1% and 10%.

In the aforesaid planting sponge, the at least one far-infrared element includes a plurality of powder particles.

In the aforesaid planting sponge, the planting sponge has a cross section of a honeycomb-shaped structure.

In the aforesaid planting sponge, the at least one far-infrared element is a ceramic far-infrared element.

In the aforesaid planting sponge, the planting sponge further comprises a surface having a plurality of cutting-slits disposed thereon.

The method for manufacturing a planting sponge of the present invention comprises the steps of:

injecting a phenolic resin raw material, at least one far-infrared element, a foaming agent and a curing agent into a stirring barrel;

stirring the phenolic resin raw material, the at least one far-infrared element, the foaming agent and the curing agent; and

injecting the stirred phenolic resin raw material, the at least one far-infrared element, the foaming agent and the curing agent into a foaming oven to form a planting sponge.

In the aforesaid method, in the step of injecting a phenolic resin raw material, at least one far-infrared element, a foaming agent and a curing agent into a stirring barrel, the ratio of the at least one far-infrared element to the phenolic resin raw material is between 1% and 10%.

In the aforesaid method, in the step of injecting a phenolic resin raw material, at least one far-infrared element, a foaming agent and a curing agent into a stirring barrel, the at least one far-infrared element is formed by a plurality of powder particles.

In the aforesaid method, in the step of injecting the stirred phenolic resin raw material, the at least one far-infrared element, the foaming agent and the curing agent into a foaming oven to form a planting sponge, the planting sponge has a cross section of a honeycomb-shaped structure.

In the aforesaid method, after the step of injecting the stirred phenolic resin raw material, the at least one far-infrared element, the foaming agent and the curing agent into a foaming oven to form a planting sponge, the method further comprises a step of: cutting the planting sponge into a plurality of planting sponge units.

In the aforesaid method, the planting sponge further comprises a surface having a plurality of cutting-slits disposed thereon, and by cutting the plurality of cutting-slits of the planting sponge, a plurality of planting sponge units are formed.

### BRIEF DESCRIPTION OF THE DRAWINGS

FIG. 1 is a perspective view of a first embodiment of the present invention;

FIG. 2 is a schematic drawing showing the first embodiment of the present invention in use;

FIG. 3 is a schematic drawing showing the cross section of the structure of the first embodiment of the present invention observed with a microscope;

FIG. 4 is a perspective view of a second embodiment of the present invention;

FIG. 5 is a schematic drawing showing the second embodiment of the present invention in use;

FIG. 6 is a flow chart showing the process of manufacturing the planting sponge of the present invention; and

FIG. 7 is a schematic drawing of an apparatus for manufacturing the planting sponge of the present invention.

### DETAILED DESCRIPTION OF THE INVENTION

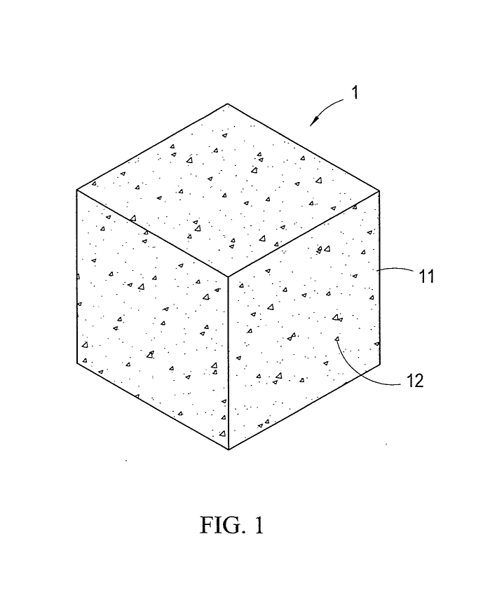

Please refer to FIG. 1, which is a perspective view of a first embodiment of the present invention. A planting sponge 1 is shown in FIG. 1, and the planting sponge 1 comprises a phenolic resin sponge body 11 and at least one far-infrared element 12, wherein the at least one far-infrared element 12 is intermixed within the phenolic resin sponge body 11.

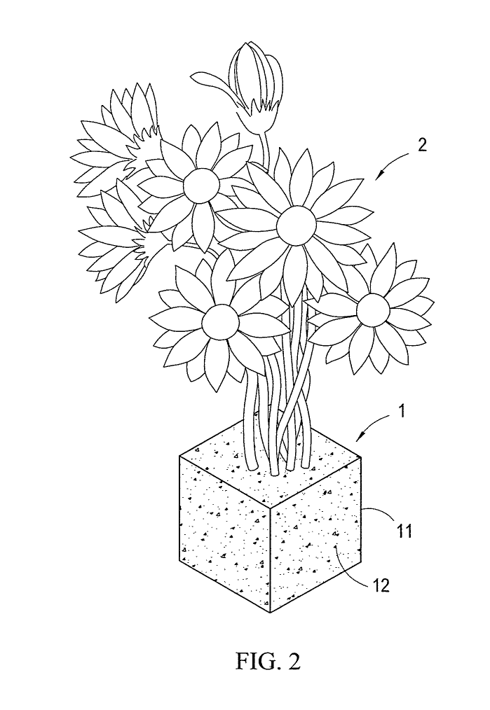

Please refer to FIG. 2, which is a schematic drawing showing the first embodiment of the present invention in use. As shown in FIG. 2, a crop 2 is planted on the planting sponge 1, and then the phenolic resin sponge body 11 body is made to absorb water (not shown) by, for example, watering or directly immersing the phenolic resin sponge body 11 into water.

In the aforesaid structure, the planting sponge 1 comprises the phenolic resin sponge body 11. The so-called “phenolic resin” is a new material developed recently that has a good stability under high temperature and uniform capillary pores, and is light-weighted, non-toxic and slightly acidic, and also has a good water-bearing and water-absorbing ability to provide the crop with the necessary nutrient and appropriate pH (power of hydrogen) value during the growth of the crop 2. In other words, after the phenolic resin sponge body 11 of the planting sponge 1 absorbs the water, the water can be retained within the phenolic resin sponge body 11 and will not flow away. In addition, the phenolic resin sponge body 11 will not breed bacteria and will not be subjected to the damage due to the insects. Further, the pH value of the phenolic resin sponge body 11 is between about 5.0 to 6.0 that is most suitable for planting the crop 2. Hence, to use the phenolic resin sponge body 11 as the structure of the planting sponge 1 can increase the convenience for attendance and increase the survival rate of the crop 2 in addition to the advantages of not breeding bacteria and not being subjected to the damage due to the insects during the planting of the crop 2.

In addition, in the aforesaid structure, the planting sponge 1 also comprises the at least one far-infrared element 12, and the at least one far-infrared element 12 has the advantages for the planting of the crop 2 as follows: (1) increasing the growth of the crop: the far-infrared can raise the temperature, activate the cell tissue of the crop 2, promote the metabolism and increase the growth of the crop; and (2) bacteriostasis and sterilization: the far-infrared has the effects of bacteriostasis and sterilization such that the crop 2 is more healthy. Further, for the cutting propagation, due to the resonance principle of the far-infrared, the at least one far-infrared element 12 can promote the healing of the wound of the plant to promote the rooting, and the sterilization function of the far-infrared could replace the use of the conventional rooting agent to avoid the infection and putrefacton of the cutting cuts. Furthermore, for the seed seedling, due to the function of procreation light wave of the far-infrared, the at least one far-infrared element 12 can promote the enzymes synthesis within the plumule of the seed to increase the germination, and the sterilization function of the far-infrared can effectively increase the chance of success of the seed seedling such that the bred seedling can grow fast and even.

In summary, the structure design of the planting sponge 1 at least has the advantages as follows: (1) promoting the growth of the crop: the growth of the crop 2 if using the planting sponge 1 to plant the crop 2 will be faster than that using the conventional planting manner with soil, for example, two to three times faster; (2) the planting sponge 1 having trace minerals such as silicon, aluminum, iron, calcium, potassium and etc. that can promote the growth of the crop 2; (3) having the effect of bacteriostasis and sterilization, which avoids the damage due to the insects such that the crop 2 is more healthy; (4) having uniform capillary pores: the capillary pores of the planting sponge 1 are uniform and are suitable for developing of the root (not shown) of the crop 2; i.e., the planting sponge 1 being an excellent media for planting the crop 2, and when used in the cutting of the crop 2, the chance of success being approximate to 100% and the survival rate of the crop 2 being very high; (5) being high temperature resistance: the planting sponge 1 will not deteriorate or deform due to the high temperature from sunshine when the planting sponge 1 is used outdoors; (6) being light-weighted: the weight of the planting sponge 1 is half of that of the conventional soil and thus the planting sponge 1 is suitable for roof greening or vertical wall greening; (7) being chemical resistance: the planting sponge 1 can resist dissolution by any chemical substances; (8) having water retention ability and air permeability: the planting sponge 1 can absorb the water of which the amount is, for example, about 50 times the original weight of the planting sponge 1, and the planting sponge 1 will not continue to absorb the water when, for example, about 60% of the aforesaid water amount has been absorbed while the root of the crop 2 can keep breathing and the water will not flow away, and thus the water retention ability and the air permeability of the planting sponge 1 are excellent; (9) being environmental protective and non-toxic: the planting sponge 1 can be smashed to be recycled and stirred with the soil to improve the structure of wall sticking of the soil and to increase the air permeability and drainage ability of the soil; (10) having multi-usages and multi-functions: the planting sponge 1 can be, for example, used outdoors or indoors, can be used for planting vegetables and etc., can be used for hydroponics and can be used for ikebana and etc.; (11) being cost-effective: to plant the crop 2 with the planting sponge 1 is cost effective, i.e., the cost being lower; and (12) there being no problems such as soil falling, dust floating and etc.

In the aforesaid structure of the planting sponge 1, the ratio of the at least one far-infrared element 12 to the phenolic resin sponge body 11 is between 1% and 10%. This ratio range is derived after many practical experiments and the planting sponge 1 with this ratio range is found very helpful to the growth of the crop 2. The aforesaid numeral range can be varied depending on different crop 2 (or seeds), for example, between 1.1% and 9.5%, between 1.1% and 9.2%, between 1.2% and 9.2%, between 1.2% and 7.5%, between 1.3% and 6.5%, between 1.3% and 6%, between 1.4% and 6%, between 1.4% and 5.3%, between 1.4% and 4.5%, between 1.5% and 4.2%, between 1.5% and 3.5%, and etc.

Further, in the structure of the planting sponge 1 of this embodiment, the at least one far-infrared element 12 includes a plurality of powder particles. Optionally, the at least one far-infrared element 12 can be of one or more slice-shaped, block-shaped or other shaped portions in other embodiments.

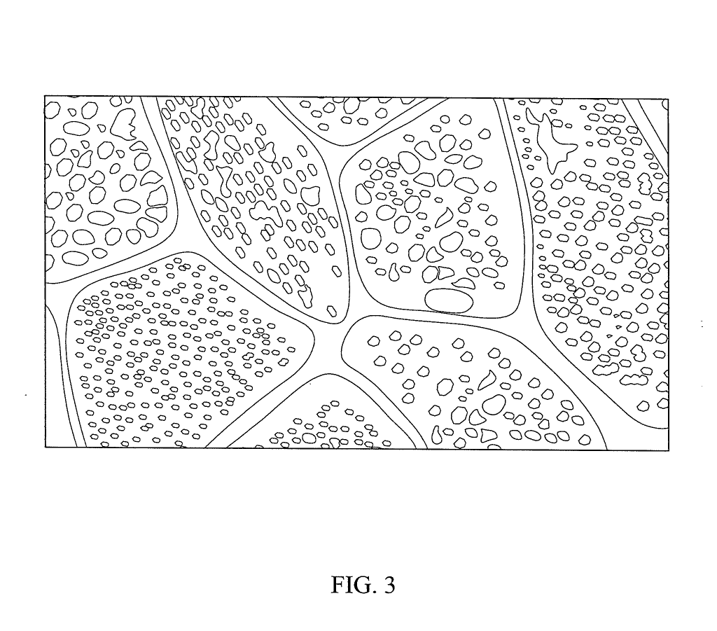

Please refer to FIG. 3, which is a schematic drawing showing the cross section structure of the first embodiment of the present invention observed with a microscope. Please also refer to FIG. 2. As shown in FIG. 3, the cross section of the planting sponge 1 observed with a microscope is of a honeycomb-shaped structure. The honeycomb-shaped structure is more convenient for the growth of the root of the crop 2; for example, it is easier for the root of the crop 2 in rooting and fixing, i.e., the crop 2 will be more easily fixed on the planting sponge 1.

The aforesaid at least one far-infrared element 12 can be a ceramic far-infrared element. Optionally, the at least one far-infrared element can be made of other materials, such as (through high-temperature calcination) pottery clay, bamboo charcoal, silica and etc.

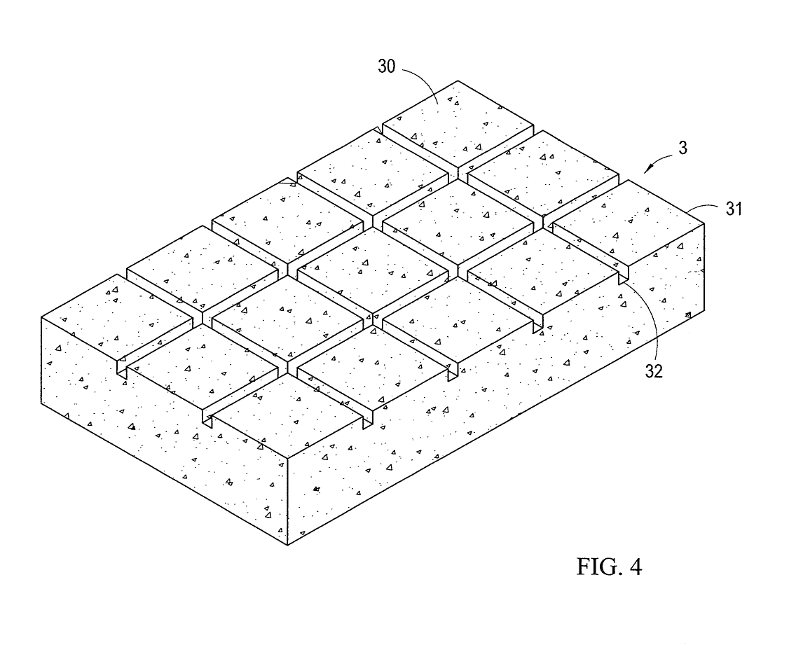

Please refer to FIG. 4, which is a perspective view of a second embodiment of the present invention. The main structure of this second embodiment is generally the same as those of the aforesaid first embodiment. The difference between this second embodiment and the aforesaid first embodiment resides in that the planting sponge 3 can be of a big planting sponge 3 in manufacturing. The planting sponge 3 comprises a surface 31 having a plurality of cutting-slits 32 disposed thereon. Hence, the big planting sponge 3 can be cut into a plurality of planting sponge units 30 (as the planting sponge 1 shown in FIG. 1) by cutting the cutting-slits 32.

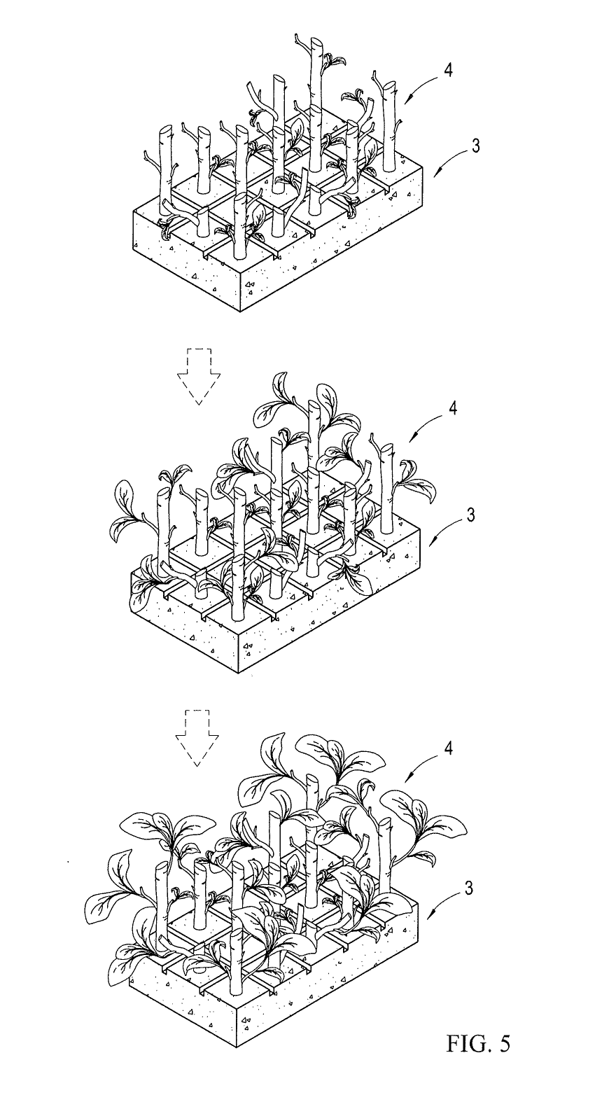

Please refer to FIG. 5, which is a schematic drawing showing the second embodiment of the present invention in use. As shown in FIG. 5, a crop 4 is planted on the planting sponge 3, and FIG. 5 shows the situations of the growth of the crop 4 after about six days, fourteen days and eighteen days through a practical experiment. Through the practical observation, it is found that the growth speed of the crop 4 is faster than that using the conventional planting with the soil.

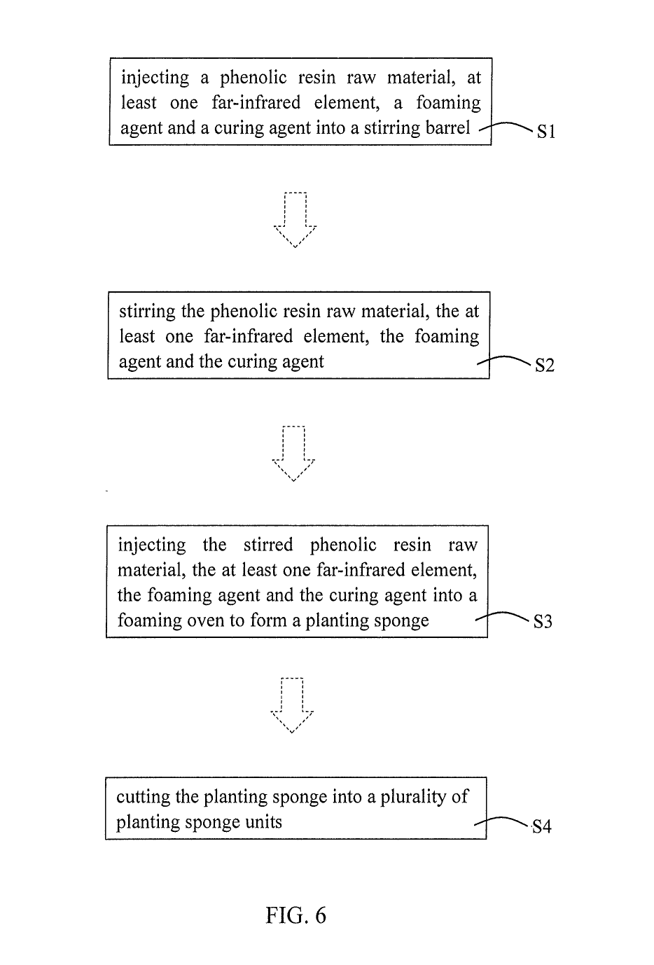

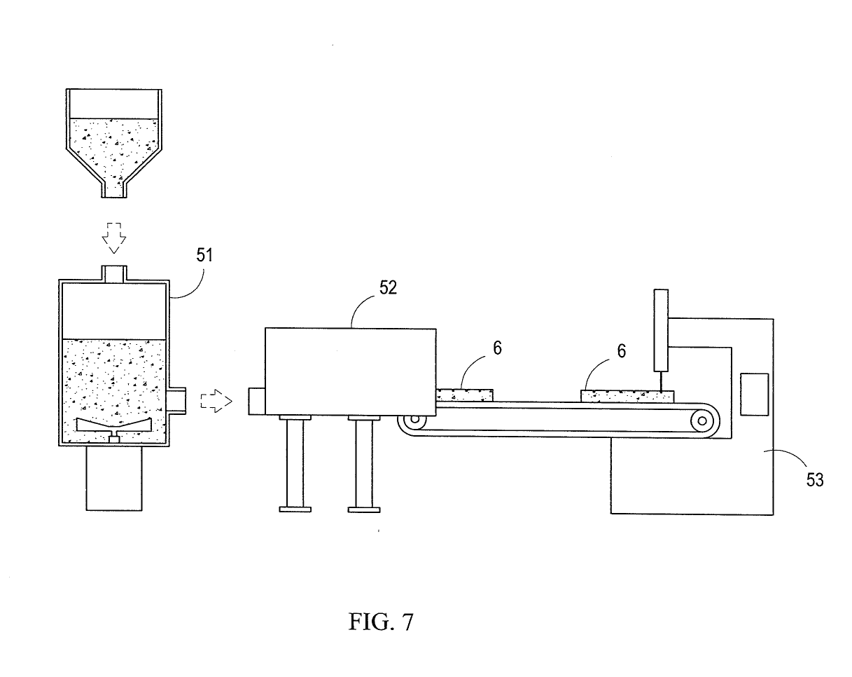

Please refer to FIG. 6 and FIG. 7, wherein FIG. 6 is a flow chart showing the process of manufacturing the planting sponge of the present invention, and FIG. 7 is a schematic drawing showing an apparatus for manufacturing the planting sponge of the present invention.

In FIG. 6 and FIG. 7, the method for manufacturing the aforesaid planting sponge is shown. The method comprises the steps of: injecting a phenolic resin raw material, at least one far-infrared element, a foaming agent and a curing agent into a stirring barrel 51 (Step S1); stirring the phenolic resin raw material, the at least one far-infrared element, the foaming agent and the curing agent (Step S2); and injecting the stirred phenolic resin raw material, the at least one far-infrared element, the foaming agent and the curing agent into a foaming oven 52 to form a planting sponge 6 (Step S3).

If the foamed planting sponge 6 is of a big planting sponge 3 as shown in FIG. 4, then after the step of injecting the stirred phenolic resin raw material, the at least one far-infrared element, the foaming agent and the curing agent into the foaming oven 52 to form the planting sponge 6, the method can further comprise a step of: cutting the planting sponge 6 into a plurality of planting sponge units (Step S4; each of the planting sponge units is the same as the planting sponge 1 as shown in FIG. 1).

In addition, if the foamed planting sponge 6 is of a big planting sponge 3 as shown in FIG. 4, then the planting sponge 6 comprises a surface with a plurality of cutting-slits disposed thereon, and by cutting the plurality of cutting-slits of the planting sponge 6, a plurality of planting sponge units (each of the planting sponge units is the same as the planting sponge 1 as shown in FIG. 1) are formed. The cutting can be performed by means of a general cutting machine 53. The structure of the surface and cutting-slits of the planting sponge 6 is the same as that of the surface 31 and cutting-slits 32 as shown in FIG. 4, and thus is not shown with a separate drawing.

In the manufacturing, the aforesaid planting sponge can be integrally formed in a modularizing manner in order to be produced massively, and the quality of the planting sponge can be maintained in an excellent condition. In addition, the planting sponge can be used together with different flower containers or aquariums to increase the variety and interest in use. Further, the ability of cleaning the indoor aircan be strengthened if the planting sponge is used indoors.

As mentioned above, in the step of injecting the phenolic resin raw material, the at least one far-infrared element, the foaming agent and the curing agent into the stirring barrel 51, the ratio of the at least one far-infrared element to the phenolic resin raw material is between 1% and 10%. The aforesaid numeral range can be varied as mentioned above.

Further, as mentioned above, in the step of injecting the phenolic resin raw material, the at least one far-infrared element, the foaming agent and the curing agent into the stirring barrel 51, the at least one far-infrared element is of a plurality of powder particles. The at least one far-infrared element can optionally be of one or more slice-shaped, block-shaped or other shaped portions in different embodiments.

Further, as mentioned above, in the step of injecting the stirred phenolic resin raw material, the at least one far-infrared element, the foaming agent and the curing agent into the foaming oven 52 to form the planting sponge 6, the cross section of the planting sponge 6 is of a honeycomb-shaped structure (please refer to FIG. 3).

What is claimed is:

1. A planting sponge, comprising:
a phenolic resin sponge; and
at least one far-infrared element intermixed within the phenolic resin sponge.

2. The planting sponge according to claim 1, wherein the ratio of the at least one far-infrared element to the phenolic resin sponge is between 1% and 10%.

3. The planting sponge according to claim 1, wherein the at least one far-infrared element includes a plurality of powder particles.

4. The planting sponge according to claim 1, wherein the planting sponge has a cross section of a honeycomb-shaped structure.

5. The planting sponge according to claim 1, wherein the at least one far-infrared element is a ceramic far-infrared element.

6. The planting sponge according to claim 1, wherein the planting sponge further comprises a surface having a plurality of cutting-slits disposed thereon.

7. A method for manufacturing a planting sponge, comprising the steps of:
injecting a phenolic resin raw material, at least one far-infrared element, a foaming agent and a curing agent into a stirring barrel;
stirring the phenolic resin raw material, the at least one far-infrared element, the foaming agent and the curing agent; and
injecting the stirred phenolic resin raw material, the at least one far-infrared element, the foaming agent and the curing agent into a foaming oven to form a planting sponge.

8. The method according to claim 7, wherein in the step of injecting a phenolic resin raw material, at least one far-infrared element, a foaming agent and a curing agent into a stirring barrel, the ratio of the at least one far-infrared element to the phenolic resin raw material is between 1% and 10%.

9. The method according to claim 7, wherein in the step of injecting a phenolic resin raw material, at least one far-infrared element, a foaming agent and a curing agent into a stirring barrel, the at least one far-infrared element includes a plurality of powder particles.

10. The method according to claim 7, wherein in the step of injecting the stirred phenolic resin raw material, the at least one far-infrared element, the foaming agent and the curing agent into a foaming oven to form a planting sponge, the planting sponge has a cross section of a honeycomb-shaped structure.

11. The method according to claim 7, further comprising a step of cutting the planting sponge into a plurality of planting sponge units after the step of injecting the stirred phenolic resin raw material, the at least one far-infrared element, the foaming agent and the curing agent into a foaming oven to form a planting sponge.

12. The method according to claim 11, wherein the planting sponge further comprises a surface having a plurality of cutting-slits disposed thereon, and by cutting the plurality of cutting-slits of the planting sponge, the plurality of planting sponge units are formed.
